(19) United States
(12) Patent Application Publication
(10) Pub. No.: US 2026/0051241 A1
(43) Pub. Date: Feb. 19, 2026

(54) METHOD AND DEVICE FOR PROVIDING TRAFFIC INFORMATION FOR ESTIMATED ENTRY TIME OF ARRIVAL AT POINTS OF INTEREST (POI) IN NAVIGATION

(71) Applicant: HYUNDAI AUTOEVER CORP., Seoul (KR)

(72) Inventors: Jung Min PARK, Seoul (KR); Jo Hyun SHIN, Seoul (KR)

(21) Appl. No.: 19/295,327

(22) Filed: Aug. 8, 2025

(30) Foreign Application Priority Data
Aug. 14, 2024 (KR) 10-2024-0108785

(51) Int. Cl. G08G 1/01; G01C 21/34

(52) U.S. Cl. CPC G08G 1/0141; G01C 21/3492; G08G 1/0112; G08G 1/012

(57) ABSTRACT

Methods and apparatuses for providing an estimated time of arrival at a point of interest (POI) in a navigation system are described. According to one embodiment, the method includes collecting driving data and trajectory data, generating parking time data of the vehicles by deriving times required for the vehicles to park based on the trajectory data and integrating the times required for the vehicles to park, deriving travel times of the vehicles traversing links leading to an entrance to the parking lot based on the driving data, calculating the vehicles' entry wait times by aggregating the travel times, and generating entry wait time data by integrating the vehicles' entry wait times, and deriving estimated times of arrival of the vehicles by summing the times required for the vehicles to park and the entry wait times, and generating estimated arrival time data by integrating the vehicles' estimated times of arrival.

### CROSS REFERENCE TO RELATED APPLICATION

This application claims the benefit of and priority to Korea Patent Application No. 10-2024-0108785, filed on Aug. 14, 2024, the entire contents of which are hereby incorporated herein by reference.

### FIELD OF TECHNOLOGY

The present disclosure relates to a method and apparatus for providing traffic information for an estimated time of arrival in a navigation system, that support efficient display of geographic data on a map.

In particular, the present disclosure relates to a method and apparatus for providing a navigation user with traffic information for an estimated time of arrival and a congestion level, by deriving an estimated time of arrival by measuring wait time for entry into a large-scale point of interest and time required for parking.

### BACKGROUND

A navigation system is a system developed to provide instructions to guide a user to a destination along an optimal route. Navigation systems work primarily by determining the user's current location based on a global positioning system (GPS) and calculating the route to the destination using a map database. However, these systems have limitations because they provide a route merely based on distance and road information, without incorporating real-time traffic situations.

Moreover, traffic information, such as real-time speed and predicted speed, provided through the navigation system is generated and processed for each road link on a geographic information system (GIS) and utilized to derive an estimated time of arrival (ETA).

More recently, navigation systems provide various information such as a congestion level and parking availability at a destination, as well as simply providing route guidance. However, in the case of a large-scale point of interest (POI), it can often take a considerable amount of time to enter and park, which makes it essential to make accurate predictions.

Incidentally, an estimated time of arrival (ETA) to a point of interest (POI) such as a shopping complex is calculated with respect to an entry link to a parking lot of the point of interest (POI) as a destination for route planning.

Accordingly, traffic information currently provided for an estimated time of arrival does not account for neither the time required for parking nor the time required to enter a parking space, when it comes to places like an underground parking lot for which no road links are provided on a geographic information system (GIS).

### SUMMARY

Against this background, the present disclosure is directed to providing a method and apparatus for providing traffic information for an estimated time of arrival in a navigation system, capable of deriving a time required for parking by collecting vehicles' driving data and trajectory data.

In an aspect, the present disclosure is directed to providing a method and apparatus for providing traffic information for an estimated time of arrival in a navigation system, capable of deriving a parking lot entry wait time by aggregating travel times of vehicles traversing the links preceding a parking lot entry link.

In an aspect, the present disclosure is directed to providing a method and apparatus for providing traffic information for an estimated time of arrival in a navigation system, capable of presenting an optimal route by analyzing a pattern of times of arrival at a point of interest (POI), which is obtained by summing the time required for each vehicle to park and each vehicle's entry wait time, and predicting traffic information for an estimated time of arrival through the analysis of the pattern.

In view of the above, an embodiment of the present disclosure provides a method for providing traffic information for an estimated time of arrival at a point of interest (POI) in a navigation system, the method including: collecting driving data and trajectory data, the driving data including information of vehicles driving via links defined by a predefined route, and the trajectory data including information obtained through a global positioning system (GPS), with respect to trajectories of vehicles moving along a non-predefined route within a parking lot; generating parking time data of the vehicles by deriving times required for the vehicles to park based on the trajectory data and integrating the times required for the vehicles to park; deriving travel times of the vehicles traversing links leading to an entrance to the parking lot based on the driving data, calculating the vehicles' entry wait times by aggregating the travel times, and generating entry wait time data by integrating the vehicles' entry wait times; and deriving an estimated time of arrival by summing the time required for parking and the entry wait time, and generating estimated arrival time data by integrating the vehicles' estimated times of arrival. (Here, the links refer to a road network on a navigation map of a geographic information system (GIS)).

Furthermore, in the present embodiment, the driving data may include link IDs corresponding to the links and entry times tₚ₋ₙ at which vehicles arrive at entrances of the links, and the trajectory data may include position coordinates of the vehicles in motion collected through the global positioning system (GPS), trajectory information transmission times t_{g-m}, and the number c_{g-m} of trajectory records collected between consecutive trajectory information transmission times. (Here, tₚ₋ₙ denotes the time at which the vehicle reaches the entrance of an n-th link from the point of interest (POI), and t_{g-m} denotes the time at which trajectory information of a vehicle is transmitted through the global positioning system (GPS) during an m-th transmission interval after the vehicle leaves the exit of the first link from the point of interest (POI), where n and m are natural numbers.)

Furthermore, in the present embodiment, the time required for parking may be defined as a value obtained by subtracting a parking lot entry time from a parking completion time.

Furthermore, in the present embodiment, the time required for parking may be defined as parking completion time (tₚ) minus parking lot entry time (tₒₚ), where tₒₚ₋=t_{g-1}.

Furthermore, in the present embodiment, if the number of trajectory records collected within a trajectory information transmission interval falls short of the maximum number of trajectory records collected by more than a margin of error, the vehicle may be deemed to be in Park position, and the parking completion time may be derived.

Furthermore, in the present embodiment, the margin of error may be 20.

Furthermore, in the present embodiment, the maximum number of trajectory records collected may be 30.

Furthermore, in the present embodiment, given that t_{g-(m+1)}−t_{g-m}=T (sec), k may be defined as the smallest value of m such that T>c_{g-m}+ (T−10), where tₚ₋=t_{g-k}. (Here, T denotes the vehicle's trajectory information transmission interval for each vehicle terminal type using a global positioning system (GPS))

Furthermore, in the present embodiment, the trajectory information transmission interval may be 30 seconds.

Furthermore, in the present embodiment, the condition T=30 (sec) may be satisfied.

Furthermore, in the present embodiment, the entry wait time may be defined as the sum of travel times through a number of consecutive links.

Furthermore, in the present embodiment, the travel time t_{que}−n may be defined as tₚ₋₍ₙ₊₁₎−tₚ₋₍ₙ₊₂₎, and the entry wait time may be defined as

$${\sum }_{n = 1}^{s} {t}_{que - n} .$$

(Here, t_{que-n} is the travel time through an (n+2)th link from the point of interest (POI), and s is a natural number).

Furthermore, in the present embodiment, the condition s=5 may be satisfied.

Furthermore, in the present embodiment, the method may further include generating daily data and day-of-week data as the generated estimated arrival time data.

Furthermore, in the present embodiment, the method may further include: generating day-of-week estimated arrival time data through pattern analysis of the day-of-week data; and providing in real time an estimated time of arrival on the date and time when a vehicle is expected to arrive at the point of interest (POI), based on the day-of-week estimated arrival time data.

Furthermore, in the present embodiment, in the generating of day-of-week estimated arrival time data, pattern analysis may be performed by integrating N weeks of day-of-week data.

Furthermore, in the present embodiment, the pattern analysis may include an analysis in which a representative value is extracted from the N weeks of day-of-week data.

Furthermore, in the present embodiment, N may be 4.

Furthermore, in the present embodiment, in the providing of an estimated time of arrival in real time, a plurality of links leading to an entrance to the parking lot and estimated times of arrival corresponding to the plurality of links may be further provided in real time.

Furthermore, in the present embodiment, in the providing of an estimated time of arrival in real time, a congestion level may be determined according the estimated time of arrival, and the congestion level may be further provided in real time.

Furthermore, in the present embodiment, the congestion level may include at least one of light, moderate, or heavy.

Furthermore, in the present embodiment, in the collecting of driving data and trajectory data, each vehicle's driving data may be collected based on input of link IDs for the point of interest (POI), vehicle IDs and entry times tₚ₋ₙ at which the vehicles reach the entrances of the links may be derived from the driving data, and each vehicle's trajectory data may be collected by incorporating the vehicle IDs and the entry times tₚ₋ₙ into the trajectory data. (Here, tₚ₋ₙ is the time of arrival at the entrance of an n-th link from the point of interest (POI), and n is a natural number.).

Furthermore, in the present embodiment, in the generating of entry wait time data, the travel times of the vehicles traversing M links may be derived by incorporating the vehicle IDs and the entry times tₚ₋ₙ into the driving data and extracting the M links in reverse chronological order of each vehicle's entry time. (Here, tₚ₋ₙ is the time of arrival at the entrance of an n-th link from the point of interest (POI), and n is a natural number.).

Furthermore, in the present embodiment, the entry wait time may be calculated by aggregating the travel times through the M links.

Furthermore, in the present embodiment, M may be 5.

Furthermore, in the present embodiment, the method may further include: generating day-of-week estimated arrival time data through pattern analysis of the day-of-week data; and providing in real time on a display an estimated time of arrival on the date and time when a vehicle is expected to arrive at the point of interest (POI), based on the day-of-week estimated arrival time data, when planning a route to the point of interest (POI).

Furthermore, in the present embodiment, in the generating of day-of-week estimated arrival time data, a representative value may be extracted from the N weeks of day-of-week data.

Furthermore, in the present embodiment, in the providing of an estimated time of arrival in real time on a display, a plurality of links leading to an entrance to the parking lot and estimated times of arrival corresponding to the plurality of links may be further provided in real time.

An embodiment of the present disclosure provides a computer-readable recording medium storing a program capable of executing the above method.

An embodiment of the present disclosure provides an apparatus for providing traffic information for an estimated time of arrival at a point of interest (POI) in a navigation system, the apparatus including: a driving and trajectory data collecting circuit for collecting driving data and trajectory data, the driving data including information of vehicles driving via links defined by a predefined route, and the trajectory data including information obtained through a global positioning system (GPS), with respect to trajectories of vehicles moving along a non-predefined route within a parking lot; a parking time data generation circuit for generating parking time data of the vehicles by deriving times required for the vehicles to park based on the trajectory data and integrating the times required for the vehicles to park; an entry wait time data generation circuit for deriving travel times of the vehicles traversing links leading to an entrance to the parking lot based on the driving data, calculating the vehicles' entry wait times by aggregating the travel times, and generating entry wait time data by integrating the vehicles' entry wait times; and an estimated arrival time data generation circuit for deriving an estimated time of arrival by summing the time required for parking and the entry wait time, and generating estimated arrival time data by integrating the vehicles' estimated times of arrival. (Here, the links refer to a road network on a navigation map of a geographic information system (GIS)).

Furthermore, in the present embodiment, the driving data may include link IDs corresponding to the links and entry times at which vehicles arrive at entrances of the links, and the trajectory data may include position coordinates of the vehicles in motion collected through the global positioning system (GPS), trajectory information transmission times, and the number of trajectory records collected between consecutive trajectory information transmission times.

Furthermore, in the present embodiment, the time required for parking may be defined as a value obtained by subtracting a parking lot entry time from a parking completion time, and if the number of trajectory records collected within a trajectory information transmission interval falls short of the maximum number of trajectory records collected by more than a margin of error, the vehicle may be deemed to be in Park position, and the parking completion time may be derived.

Furthermore, in the present embodiment, the entry wait time may be defined as the sum of travel times through a number of consecutive links.

Furthermore, in the present embodiment, the apparatus may further include a day-of-week estimated time data generation circuit for generating daily data and day-of-week data as the generated estimated arrival time data, and for generating day-of-week estimated arrival time data through pattern analysis of the day-of-week data; and an estimated arrival time provision screen for providing in real time on a display an estimated time of arrival on the date and time when a vehicle is expected to arrive at the point of interest (POI), based on the day-of-week estimated arrival time data.

Furthermore, in the present embodiment, the estimated arrival time provision screen may determine a congestion level according the estimated time of arrival, and may further provide the determined congestion level in real time.

As explained above, according to the present disclosure, it is possible to predict time required for parking in a place for which no links are provided, by collecting vehicles' link driving data and trajectory data.

Furthermore, according to the present disclosure, it is possible to accurately derive a parking lot entry time based on travel times of vehicles traversing the links preceding an entry link to a parking lot of a point of interest (POI).

Furthermore, according to the present disclosure, it is possible to provide traffic information for an estimated time of arrival at a place for which no links are provided, by analyzing a pattern of estimated times of arrival at a point of interest (POI) based on times required for vehicles to park in a parking lot and the vehicles' entry wait times.

Furthermore, according to the present disclosure, it is possible to present an optimal route by analyzing a pattern of estimated times of arrival at a point of interest (POI) based on times required for vehicles to park in a parking lot and the vehicles' entry wait times.

Furthermore, according to the present disclosure, it is possible to provide an estimated time of arrival at a point of interest (POI) during route planning.

Furthermore, according to the present disclosure, it is possible to provide an estimated time of arrival at a point of interest (POI) in real time.

Furthermore, according to the present disclosure, it is possible to provide an estimated time of entry for each parking lot entrance in real time or during route planning by comparing estimated times of entry for a plurality of parking lot entrances of a point of interest (POI) and congestion levels at the parking lot entrances.

### BRIEF DESCRIPTION OF THE DRAWINGS

FIG. 1 is a view depicting a point of interest and entry links, in a navigation system according to the related art.

FIG. 2 is a flowchart of a method for providing traffic information for an estimated time of arrival at a point of interest (POI) in a navigation system according to an embodiment of the present disclosure.

FIG. 3 is an enlarged view of a portion of traffic information and a link, in a method for providing traffic information for an estimated time of arrival at a point of interest (POI) in a navigation system according to an embodiment.

FIG. 4 is a view depicting a method of deriving a time required for parking according to a method for providing traffic information for an estimated time of arrival at a point of interest (POI) in a navigation system according to an embodiment.

FIG. 5 is a view depicting data and tables, for a method of deriving a time required for parking according to a method for providing traffic information for an estimated time of arrival at a point of interest (POI) in a navigation system according to an embodiment.

FIG. 6 is a view depicting a method of deriving an entry wait time according to a method for providing traffic information for an estimated time of arrival at a point of interest (POI) in a navigation system according to an embodiment.

FIG. 7 is a view depicting data and tables, for a method of deriving an entry wait time according to a method for providing traffic information for an estimated time of arrival at a point of interest (POI) in a navigation system according to an embodiment.

FIG. 8 is a flowchart of a method for providing traffic information for an estimated time of arrival at a point of interest (POI) in a navigation system according to an embodiment.

FIG. 9 is a flowchart of a method for providing traffic information for an estimated time of arrival at a point of interest (POI) in a navigation system according to an embodiment.

FIG. 10 is a flowchart of a method for providing traffic information for an estimated time of arrival at a point of interest (POI) in a navigation system according to an embodiment.

FIG. 11 is a flowchart of a method for providing traffic information for an estimated time of arrival at a point of interest (POI) in a navigation system according to an embodiment.

FIG. 12 is a flowchart of a method for providing traffic information for an estimated time of arrival at a point of interest (POI) in a navigation system according to an embodiment.

FIG. 13 is a view showing a daily trend of times of arrival at a specific point of interest, according to a method for providing traffic information for an estimated time of arrival at a point of interest (POI) in a navigation system.

FIG. 14 is a view showing a trend of times of arrival at a specific point of interest over a four-week period, according to a method for providing traffic information for an estimated time of arrival at a point of interest (POI) in a navigation system according to an embodiment.

FIG. 15 is a view depicting an on-screen display showing estimated times of arrival and congestion levels at a specific point of interest, according to a method for providing traffic information for an estimated time of arrival at a point of interest (POI) in a navigation system according to an embodiment.

FIG. 16 is a view depicting an apparatus for providing traffic information for an estimated time of arrival at a point of interest (POI) in a navigation system according to an embodiment.

### DETAILED DESCRIPTION

Hereinafter, some embodiments of the present disclosure are described in detail with reference to the accompanying drawings. With regard to the reference numerals of the components of the respective drawings, it should be noted that the same reference numerals are assigned to the same components even when the components are shown in different drawings. In addition, in describing the present disclosure, detailed descriptions of well-known configurations or functions have been omitted in order to not obscure the gist of the present disclosure.

In addition, terms such as “1st”, “2nd”, “A”, “B”, “(a)”, “(b)”, or the like may be used in describing the components of the present disclosure. These terms are intended only for distinguishing a corresponding component from other components, and the nature, order, or sequence of the corresponding component is not limited to the terms. In the case where a component is described as being “coupled”, “combined”, or “connected” to another component, it should be understood that the corresponding component may be directly coupled or connected to another component or that the corresponding component may also be “coupled”, “combined”, or “connected” to the component via another component provided therebetween.

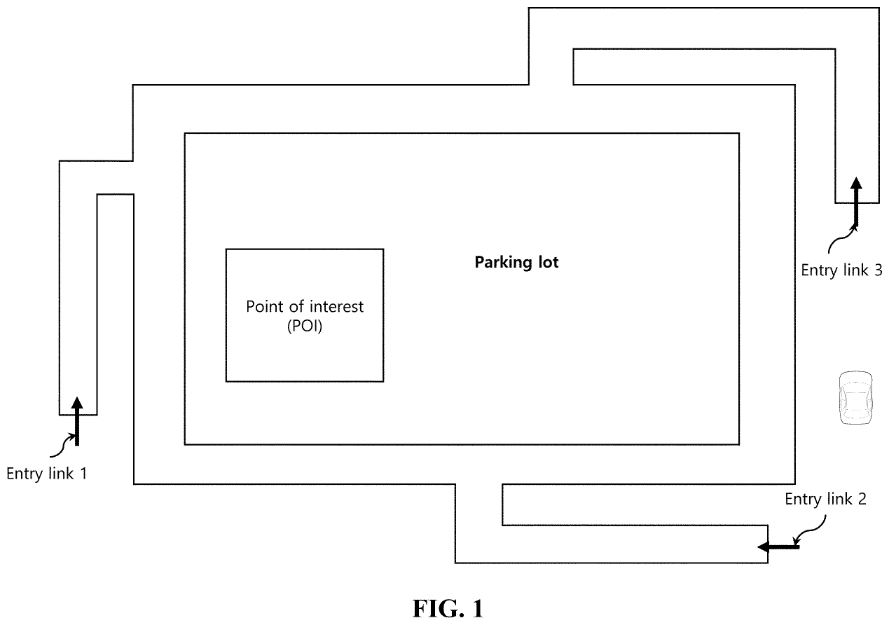

FIG. 1 is a view depicting a point of interest and entry links, in a navigation system according to the related art.

Referring to FIG. 1, it can be observed that, in a typical conventional navigation system, no links are provided within a parking lot of a point of interest.

For example, in the case of a large-scale point of interest such as a shopping complex, road links are provided within areas like underground parking lots. Thus, an estimated time of arrival needs to be calculated with respect to an entry link.

That is, in a conventional navigation system, an estimated time of arrival at a point of interest was calculated without considering the time required for parking via links, in relation to information on the vehicle's driving beyond the final link leading to a parking lot entrance in the direction of travel. For this reason, there is a large discrepancy between the estimated time of arrival that account for both the time required to reach the parking lot of the point of interest and the time required for parking in the parking lot and the estimated time of arrival provided by the conventional navigation system.

Moreover, although conventional navigation systems provide a number of entry links via which a vehicle can enter a parking lot of a point of interest, they are unable to analyze or compare and provide times required to reach the point of interest after parking in the parking lot via each entry link. Thus, the users of the navigation systems were unable to find out which parking lot entrance they should take to reach the point of interest within the shortest time.

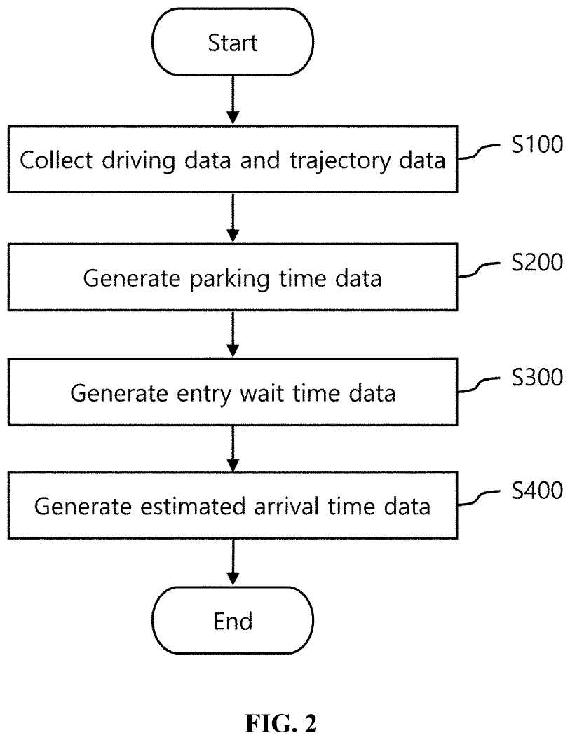

FIG. 2 is a flowchart of a method for providing traffic information for an estimated time of arrival at a point of interest (POI) in a navigation system according to an embodiment of the present disclosure.

Referring to FIG. 2, the present embodiment may provide a method for providing traffic information for an estimated time of arrival at a point of interest (POI) in a navigation system, the method including: the step S100 of collecting driving data and trajectory data, the driving data including information of vehicles driving via links defined by a predefined route, and the trajectory data including information obtained through a global positioning system (GPS), with respect to trajectories of vehicles moving along a non-predefined route within a parking lot; the step 200 of generating parking time data of the vehicles by deriving times required for the vehicles to park based on the trajectory data and integrating the times required for the vehicles to park; the step S300 of deriving travel times of the vehicles traversing links leading to an entrance to the parking lot based on the driving data, calculating the vehicles' entry wait times by aggregating the travel times, and generating entry wait time data by integrating the vehicles' entry wait times; and the step 400 of deriving an estimated time of arrival by summing the time required for parking and the entry wait time, and generating estimated arrival time data by integrating the vehicles' estimated times of arrival. (Here, the links refer to a road network on a navigation map of a geographic information system (GIS)).

According to the present embodiment, it is possible to derive times required for parking by collecting trajectories of vehicles in motion through a global positioning system (GPS), even for a place like a parking lot for which no links are provided, derive times required for the vehicles to enter a parking lot of a point of interest by accounting for both times required for parking and driving data collected from a road with links, and, as a result, provide a navigation user with an accurately estimated time of arrival by analyzing the times required for the vehicles to enter.

According to the present embodiment, the navigation system may integrate a global positioning system (GPS) with a digital map to find the user's location and guide the user to a destination along a path.

The global positioning system (GPS) may determine the user's location by using a satellite signal, and information on the user's location may be matched to links of a road on a digital map of the navigation system.

A link in a road is a basic unit representing the road on a navigation map, which may refer to a road segment between two intersections.

The navigation system may calculate an optimal route based on link information and provide guidance.

If signals from the global positioning system (GPS) are weak, artificial intelligence technology or inertial measurement unit-based dead reckoning technology may be used to complement the weak signals.

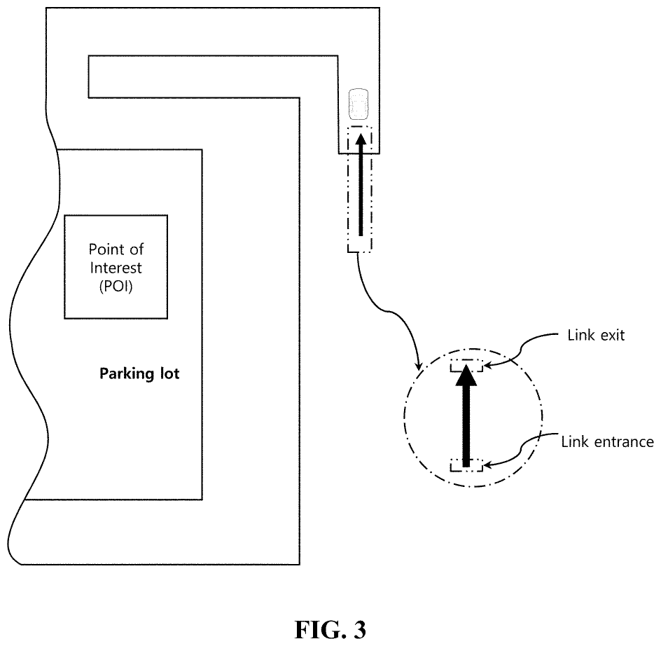

FIG. 3 is an enlarged view of a portion of traffic information and a link, in a method for providing traffic information for an estimated time of arrival at a point of interest (POI) in a navigation system according to an embodiment.

Referring to FIG. 3, a link entrance may refer to an initial entry point at which a vehicle enters the link, and a link exit may refer to an end point where a vehicle leaves the link. A vehicle may drive in an area defined by a link, a terminal mounted in the vehicle may measure the ID of a link along which the vehicle drives, the time at which the vehicle passes the link entrance, or the time the vehicle passes the link exit, and may store data such as the ID of the link and the measured times corresponding to the ID of the link.

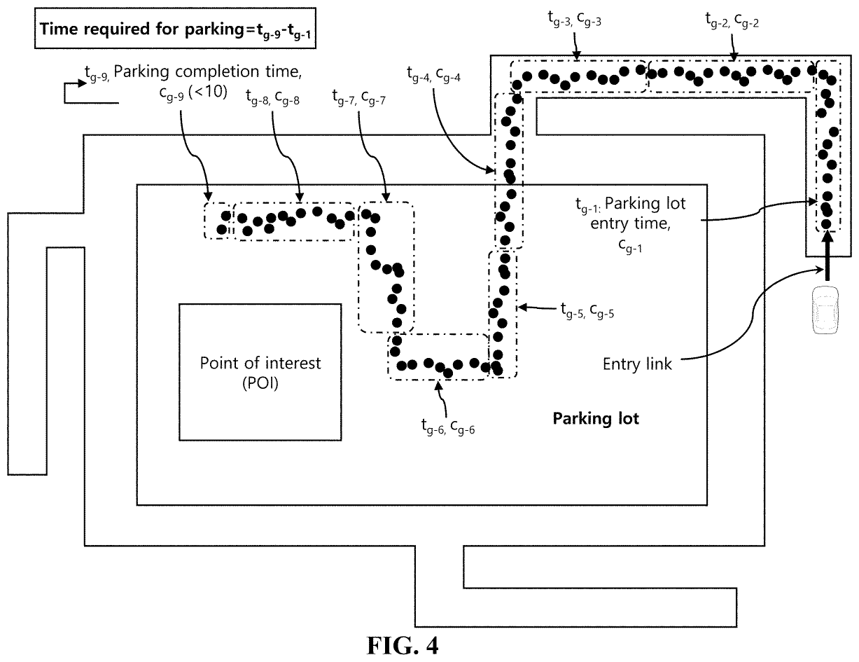

FIG. 4 is a view depicting a method of deriving a time required for parking according to a method for providing traffic information for an estimated time of arrival at a point of interest (POI) in a navigation system according to an embodiment.

Referring to FIG. 4, in the present embodiment, there may be a method for providing traffic information for an estimated time of arrival at a point of interest (POI) in a navigation system, wherein the driving data includes link IDs corresponding to the links and entry times tp−n at which vehicles arrive at entrances of the links, and the trajectory data includes position coordinates of the vehicles in motion collected through the global positioning system (GPS), trajectory information transmission times tg−m, and the number cg−m of trajectory records collected between consecutive trajectory information transmission times. (Here, tp−n denotes the time at which the vehicle reaches the entrance of an n-th link from the point of interest (POI), and tg−m denotes the time at which trajectory information of a vehicle is transmitted through the global positioning system (GPS) during an m-th transmission interval after the vehicle leaves the exit of the first link from the point of interest (POI), where n and m are natural numbers.)

According to the present embodiment, if a vehicle starts entering a parking lot with no links after leaving the exit of the final link leading to the parking lot, the global positioning system (GPS) may collect position coordinates of the vehicle's trajectory at given transmission intervals and derive whether the vehicle is driving or has completed parking based on the number of trajectory records collected between each given transmission interval.

According to the present embodiment, if the number of vehicle trajectory records collected per trajectory information transmission interval for each vehicle terminal type falls short of a reference value, the vehicle's gear may be deemed to be in “P” position, indicating that parking is completed.

According to the present embodiment, if the following (Condition 1) is met, the vehicle may be deemed to have completed parking.

(k+1)th trajectory information transmission time−kth trajectory information transmission time>number of trajectory records collected by GPS at (k+1)th trajectory information transmission time+20 (where k is a natural number.) (Condition 1)

According to the present embodiment, if Condition 1 is met and therefore the number of trajectory records collected per trajectory information transmission interval falls short of the number of trajectory records collected during the time interval between consecutive trajectory information transmission times by more than 20, the vehicle's gear may be deemed to be in P position, indicating that vehicle parking is completed.

Meanwhile, the margin of error (numerical value 20) in the above Condition 1 may be set to vary with the usage environment, and the margin of error may be calculated based on the standard error of the sample. The standard error represents the variability of the sample, through which the margin of error can be estimated.

According to the present embodiment, it is possible to accurately derive a time required for parking even in areas such as an underground parking lot for which no road links are provided, by measuring the time required for parking based on trajectory information transmission time and number of trajectory records collected.

According to the present embodiment, the time required for parking may be defined as a value obtained by subtracting a parking lot entry time from a parking completion time, and if the number of trajectory records collected within a trajectory information transmission interval falls short of the maximum number of trajectory records collected by more than a margin of error, the vehicle may be deemed to be in Park position, and the parking completion time may be derived.

The maximum number of trajectory records collected may refer to the maximum number of trajectory records that can be collected within a trajectory information transmission interval. For example, if the transmission interval is 30 sec and trajectory information is transmitted and collected once in a second, the maximum number of trajectory records collected may be 30*1=30.

According to the present embodiment, if the number of trajectory records collected within a trajectory information transmission interval falls short of the maximum number of trajectory records collected by more than the margin of error, it is assumed that parking has been completed during that transmission interval, and the parking completion time may be compared with the parking lot entry time, thereby estimating the time required for parking.

Moreover, according to the present embodiment, the time required for parking may be defined as parking completion time (tₚ) minus parking lot entry time (tₒₚ), where tₒₚ₋=t_{g-1}, and given that t_{g-(m+1)}−t_{g-m}=T (sec), k may be defined as the smallest value of m such that T>c_{g-m}+ (T−10), where tₚ₋=t_{g-k}. (Here, T denotes the vehicle's trajectory information transmission interval for each vehicle terminal type using a global positioning system (GPS)).

According to the present embodiment, the trajectory information transmission interval T may be a constant or a value defined by a variable, and may be determined according to the vehicle's terminal type.

Moreover, according to the present embodiment, the condition T=30 (sec) may be satisfied. If T can be set as a constant value of 30 (sec) depending on the vehicle terminal type, this means that trajectory information is transmitted at 30-second intervals. If the number of trajectory records collected within each transmission interval is 10 or more, the vehicle's gear is deemed to be in “D”, indicating that the vehicle is driving, and if that number is less than 10, the vehicle's gear is deemed to be in “P”, indicating that parking is completed.

According to the present embodiment, if Condition 1 is met, the time required for parking may be calculated based on the difference between the parking completion time and the first trajectory information transmission time after the vehicle has passed an entry link connected to the parking lot

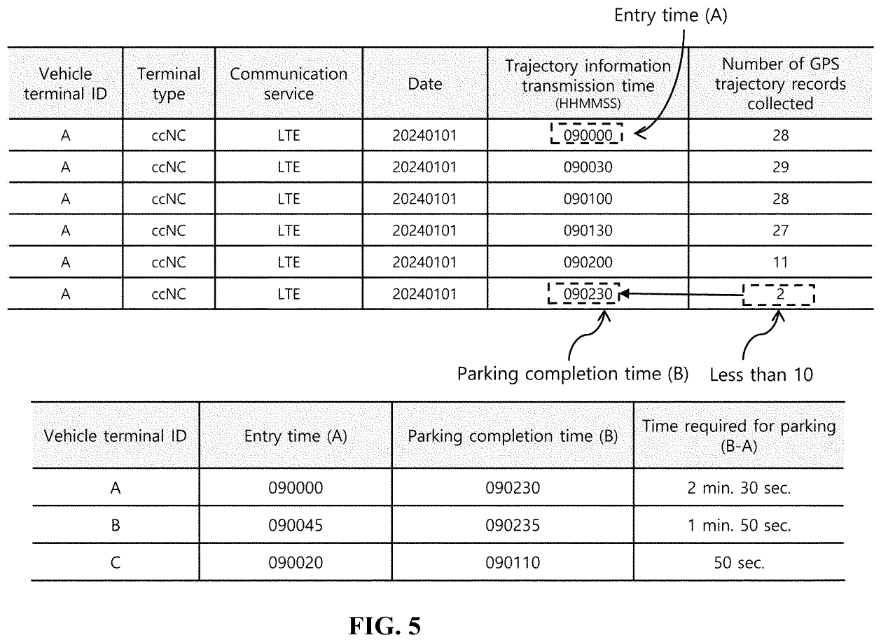

FIG. 5 is a view depicting data and tables, for a parking time derivation method according to a method for providing traffic information for an estimated time of arrival at a point of interest (POI) in a navigation system according to an embodiment.

According to the present embodiment, if the number of trajectory records collected per trajectory information transmission interval for each vehicle terminal type falls short of a reference value, the vehicle's gear may be deemed to be in “P” position, indicating that parking is completed.

Referring to the table in the upper part depicted in FIG. 5, if the vehicle terminal type is ccNC, the trajectory information transmission interval of the vehicle terminal may be 30 seconds, in which case one or more vehicle trajectory records may be collected in a second through GPS.

Referring to the table in the upper part depicted in FIG. 5, only two trajectory records are collected per 30-second interval of trajectory information at the trajectory information transmission time 09:02:30. Since this figure falls short of the reference value by which the vehicle is deemed to be driving, it may be inferred that the vehicle's gear is set to “P” position and parking is completed.

Moreover, according to the present embodiment, the vehicle terminal may calculate the time required for parking as a period of time from the arrival at a parking lot entry link to the completion of parking, which is identified based on the vehicle's trajectory information. Thus, it is possible to accurately calculate the time required for parking even in an area with no links.

In addition, according to the present embodiment, in the case of a vehicle's traffic information beyond a parking lot entry link, driving information such as speed and travel time through links can no longer be collected. Thus, the parking completion time may be determined based on the vehicle's GPS trajectory information which is transmitted by a traffic collecting terminal (TCT) and collected in accordance with a traffic information transfer protocol (TITP).

The traffic information transfer protocol (TITP) may refer to a communication protocol for data exchange between traffic information systems and also may refer to a protocol designed for traffic information transfer, which may be used for information exchange between various traffic-related systems such as traffic information centers, service providers, and traffic control centers, thereby providing enhanced functionality in terms of connectivity and stability when exchanging information between traffic-related systems.

Moreover, referring to the tables in the upper and lower parts of FIG. 5, the time required for parking may be derived through the following process shown in (Example 1).

### Example 1

Driving (D): “(09:00:30)-(09:00:00)=30 sec”<“29 records+20=49 records”
Parked (P): “(09:02:30)-(09:02:00)=30 sec”>“2 records+20=22 records”
Time required for parking: Parking completion time (09:02:30)−Entry time (09:00:00)=2 minutes and 30 seconds.

According to the present embodiment, the time required for parking can be calculated with high accuracy even in areas with no links according to the process as shown in Example 1.

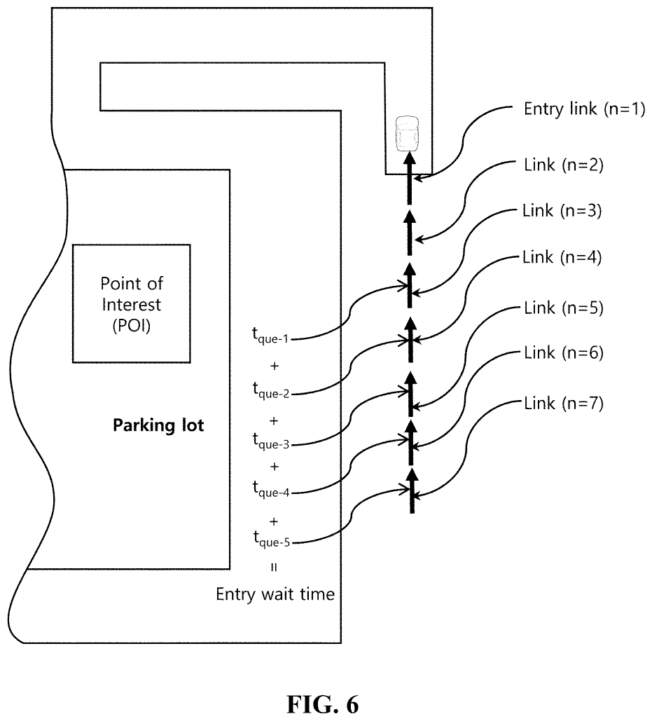

FIG. 6 is a view depicting a method of deriving an entry wait time according to a method for providing traffic information for an estimated time of arrival at a point of interest (POI) in a navigation system according to an embodiment.

Referring to FIG. 6, according to the present embodiment, for a large-scale point of interest (POI), a considerable amount of time may be required to enter the parking lot. By aggregating the travel times through links leading to the parking lot, it is possible to derive the wait time for entry into the parking lot. The entry wait time can then be used to more accurately estimate the time of arrival at the point of interest.

According to the present embodiment, the travel time t_{que}−n may be defined as tₚ₋₍ₙ₊₁₎−tₚ₋₍ₙ₊₂₎, and the entry wait time may be defined as

$${\sum }_{n = 1}^{s} {t}_{que - n} ,$$

wherein the condition s=5 is satisfied. (Here, t_{que-n} is the travel time through an (n+2)th link from the point of interest (POI), and s is a natural number).

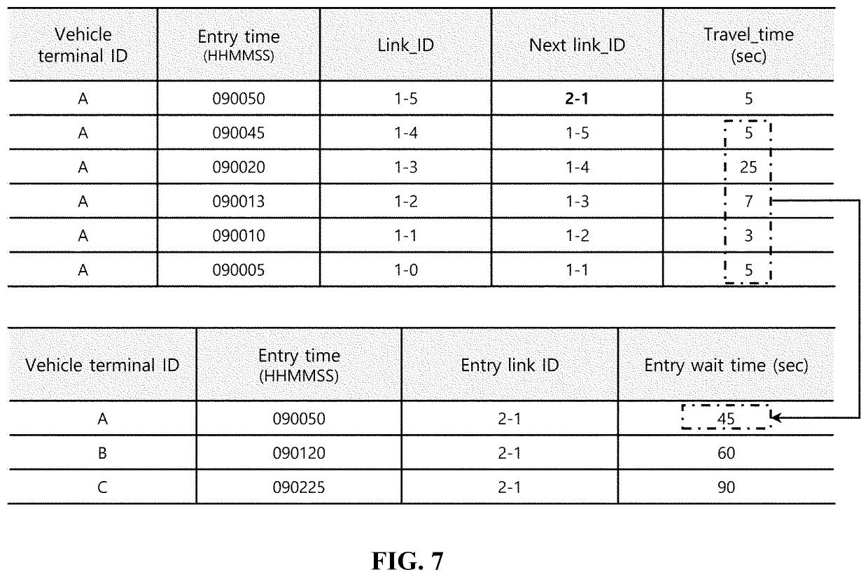

FIG. 7 is a view depicting data and tables, for a method of deriving an entry wait time according to a method for providing traffic information for an estimated time of arrival at a point of interest (POI) in a navigation system according to an embodiment.

Referring to FIG. 7, the entry wait time according to the present embodiment may be derived as shown in (Example 2).

### Example 2

### Derivation of Entry Wait Time

A wait time caused by entry queues at an entrance of a parking lot, resulting from traffic congestion near a point of interest (POI), i.e., the destination, before arrival, may be defined as “entry wait time”.

Depending on the vehicle terminal type, the entry wait time may be calculated as the sum of travel times through five links preceding the link (n=2) that comes immediately before the entry link (n=1) leading to the entrance of the parking lot.

### Example of Calculation

Entry wait time for Vehicle “A”: The sum of travel times through five links (1-0˜1-4) preceding the link (1-5) that comes immediately before the entry link (2-1)=5+25+7+3+5=45

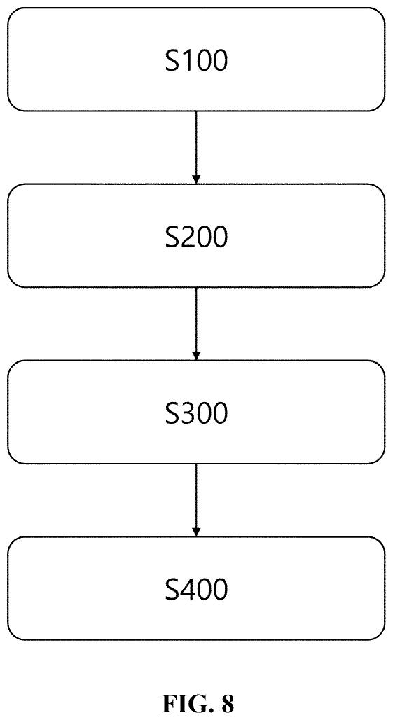

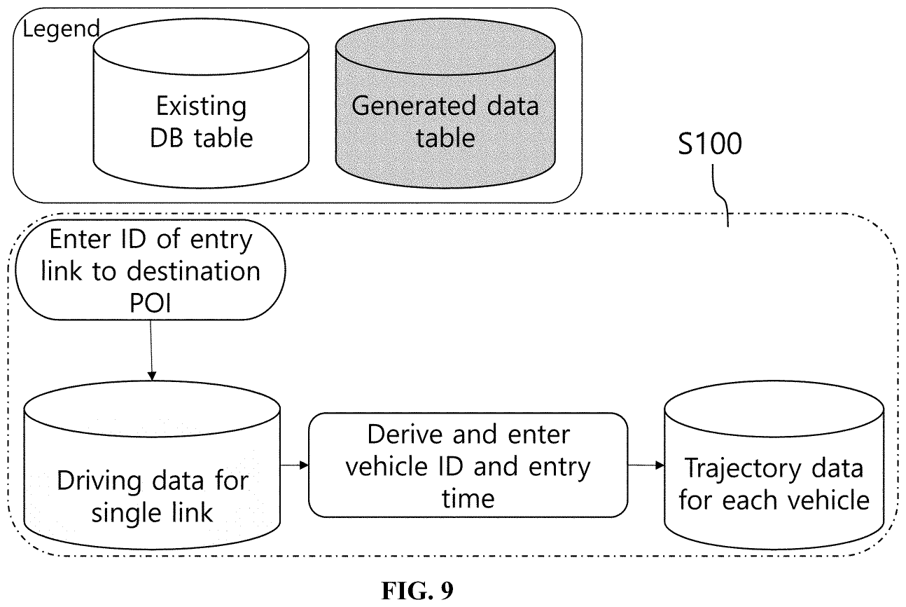

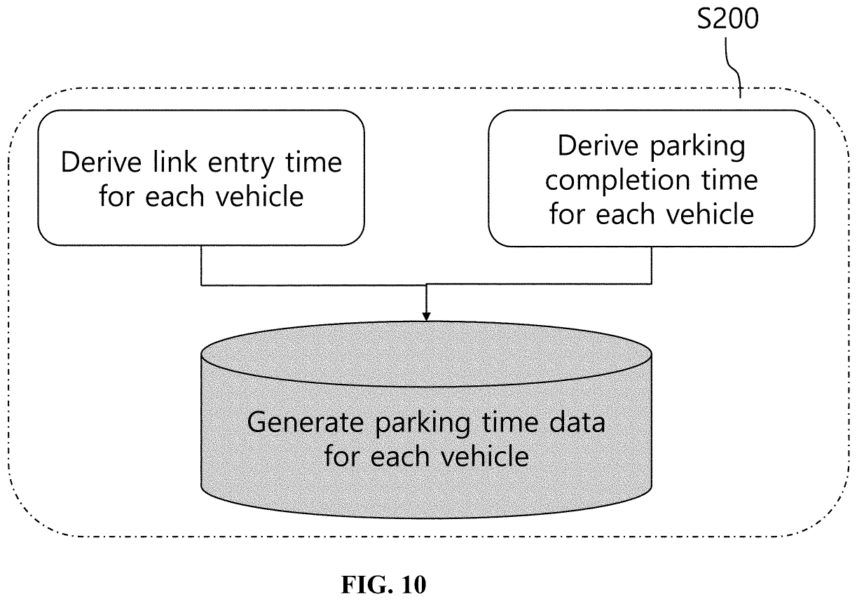

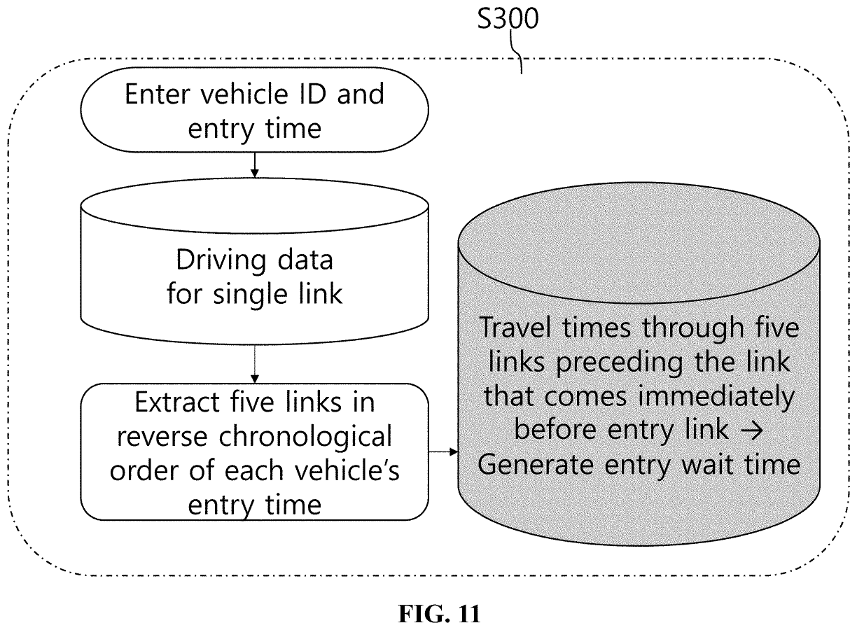

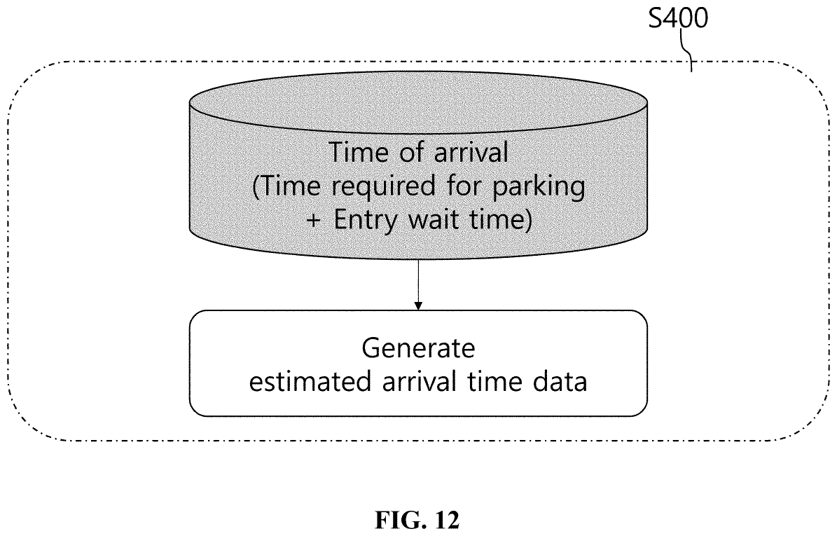

FIGS. 8 to 12 are flowcharts of a method for providing traffic information for an estimated time of arrival at a point of interest (POI) in a navigation system according to an embodiment.

Moreover, according to the present embodiment, in the step S100 of collecting driving data and trajectory data, each vehicle's driving data may be collected based on input of link IDs for the point of interest (POI), vehicle IDs and entry times tₚ₋ₙ at which the vehicles reach the entrances of the links may be derived from the driving data, and each vehicle's trajectory data may be collected by incorporating the vehicle IDs and the entry times tₚ₋ₙ into the trajectory data, and, in the step S300 of generating entry wait time data, the travel times of the vehicles traversing five links may be derived by incorporating the vehicle IDs and the entry times tₚ₋ₙ into the driving data and extracting the five links in reverse chronological order of each vehicle's entry time. (Here, tₚ₋ₙ is the time of arrival at the entrance of an n-th link from the point of interest (POI), and n is a natural number.)

According to the present embodiment, in the step of generating driving data and trajectory data, the time required for parking may be derived by organically linking driving data and trajectory data and correlating the linked data, and an estimated time of arrival may be accurately calculated by summing the derived time required for parking and the entry wait time, even for a point of interest connected to a parking lot with no links, thereby delivering more reliable traffic information.

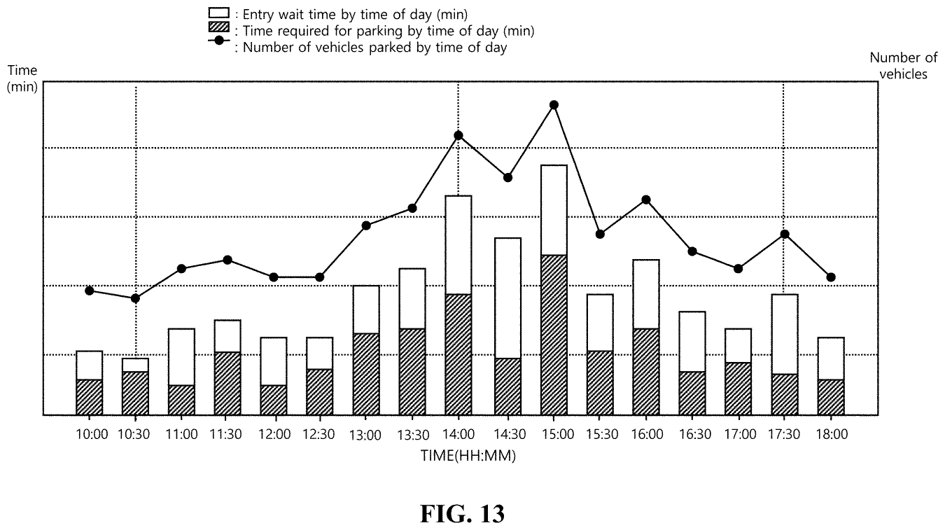

FIG. 13 is a view showing a daily trend of times of arrival at a specific point of interest, according to a method for providing traffic information for an estimated time of arrival at a point of interest (POI) in a navigation system.

Referring to FIG. 13, according to the present embodiment, the method may further include the step of generating daily data and day-of-week data as the estimated arrival time data. The number of parked vehicles, the times vehicles spent on waiting to enter, and the times spent on parking may be generated by time of day on a daily basis and utilized for pattern analysis.

According to the present embodiment, the times required for entry at an entrance leading to a specific point of interest may be generated as data on a daily basis and utilized for pattern analysis.

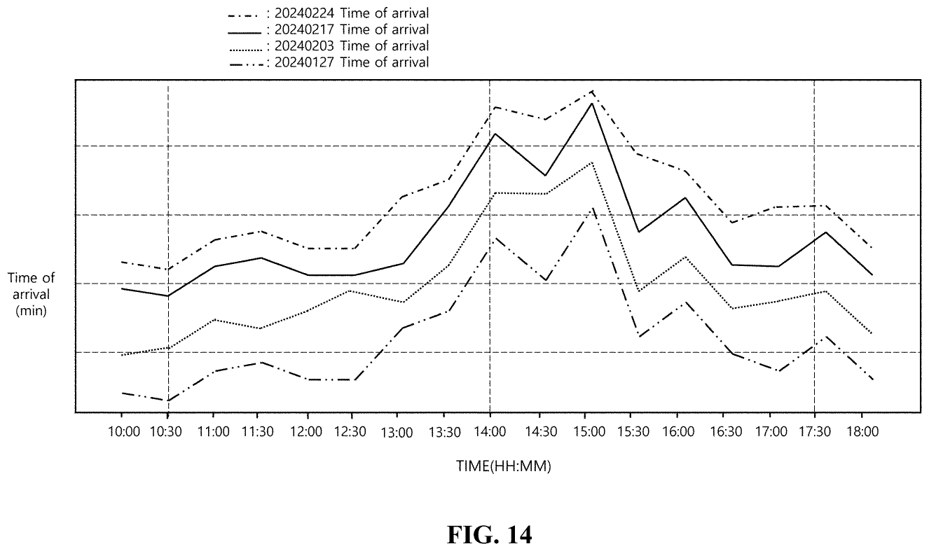

FIG. 14 is a view showing a trend of times of arrival at a specific point of interest over a four-week period, according to a method for providing traffic information for an estimated time of arrival at a point of interest (POI) in a navigation system according to an embodiment.

Referring to FIG. 14, according to the present embodiment, the method may further include: the step of generating day-of-week estimated arrival time data through pattern analysis of the day-of-week data; and the step of providing in real time an estimated time of arrival on the date and time when a vehicle is expected to arrive at the point of interest (POI), based on the day-of-week estimated arrival time data, and, in the step of generating day-of-week estimated arrival time data, pattern analysis may be performed by integrating four weeks of day-of-week data, wherein the pattern analysis includes an analysis in which a representative value is extracted from the four weeks of day-of-week data.

The pattern analysis may refer to the process of incorporating differences in traffic volume pattern between weekdays and weekends when calculating estimated times. For pattern analysis, various analytical methods may be applied within the scope required to achieve the objects of the present disclosure.

In addition, when extracting a representative value, the following methods may be applied individually or in combination, but are not limited thereto.

### Extraction of Representative Value

Calculation of Mean: A method in which the mean of data collected for each day of the week is computed and used as the representative value.
Use of Median: A method in which data is sorted and the middle value is selected as the representative value.
Mode Analysis: A method that selects the value that appears most often as the representative value
Moving Average Method: A method that calculates the representative value by continuously averaging data over a specific period.
Weighted Average: A method that assigns greater weights to recent data to calculate the average.
Percentile Analysis: A method that sorts data and selects a value corresponding to a specific percentile (e.g., the 75th percentile) as the representative value.
Clustering Technique: A method that uses a clustering algorithm such as K-means to group similar patterns and use the centroid of each cluster as the representative value.
Time Series Decomposition: A method that decomposes day-of-week patterns into components such as trend, seasonality, and residuals and extracts the representative value from each component.

Referring to FIGS. 13 and 14, according to the present embodiment, it is possible to provide traffic information for an estimated time of arrival during driving, by deriving the estimated time of arrival by summing the time required for parking and the entry wait time, analyzing the trend of entry times of vehicles at each entrance of a point of interest (POI) over a 24-hour period, and deriving day-of-week patterns over a four-week period based on daily and day-of-week data of times of arrival, thereby improving the accuracy and reliability of traffic information analysis in a navigation system.

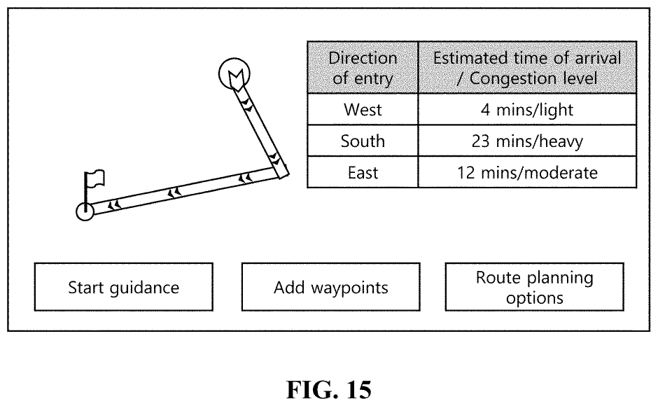

FIG. 15 is a view depicting an on-screen display showing estimated times of arrival and congestion levels at a specific point of interest, according to a method for providing traffic information for an estimated time of arrival at a point of interest (POI) in a navigation system according to an embodiment.

Referring to FIG. 15, according to the present embodiment, the method may further include: the step of generating day-of-week estimated arrival time data through pattern analysis of the day-of-week data; and the step of providing in real time an estimated time of arrival on the date and time when a vehicle is expected to arrive at the point of interest (POI), based on the day-of-week estimated arrival time data, wherein a congestion level may be determined according the estimated time of arrival, and the congestion level may be further provided in real time, wherein the congestion level may include at least one of light, moderate, or heavy.

Moreover, according to the present embodiment, in the step of providing an estimated time of arrival at the point of interest (POI) on a display during route planning, a plurality of links leading to an entrance to the parking lot and estimated times of arrival corresponding to the plurality of links may be further provided during route planning.

The display of the navigation system may refer to a key interface that visually provides various information to the user. Examples of what may be shown on the display are as follows, through these are not limited to those listed.

### (On-Screen Display)

Map display: A map can be displayed in either 2D or 3D format, showing the user's current location and the route to the destination.

Zoom function: The user can zoom in or out on the map by using finger gestures on the screen or by using a controller.

Vehicle speed display: The current vehicle speed may be shown on the map screen depending on the user settings.

Traffic information: Real-time traffic situations can be indicated using color coding, helping users easily assess them.

Surrounding information: Points of interest (POIs) icons can be used to indicate major nearby facilities

Route guidance: The route to the destination can be highlighted, and the distance and direction to the next guidance point can be indicated.

Address display: Either road name addresses or land-lot-based addresses can be shown depending on the user settings.

Guidance screen: In complex intersections or highway entrances and exits, a detailed guidance screen may be provided.

Underground parking information: When entering an underground parking lot, relevant information can be displayed to guide users to parking zones and convenience facility locations.

User interface: Menu buttons, search features, and configuration options can be placed at the top or bottom of the screen to allow users to manipulate the system with ease.

The technical concept described hitherto may be implemented as computer-readable code on a computer-readable medium. The computer program recorded on the computer-readable medium may be transmitted to other computing devices via a network such as the Internet and installed on those computing devices, and accordingly may be used on those computing devices.

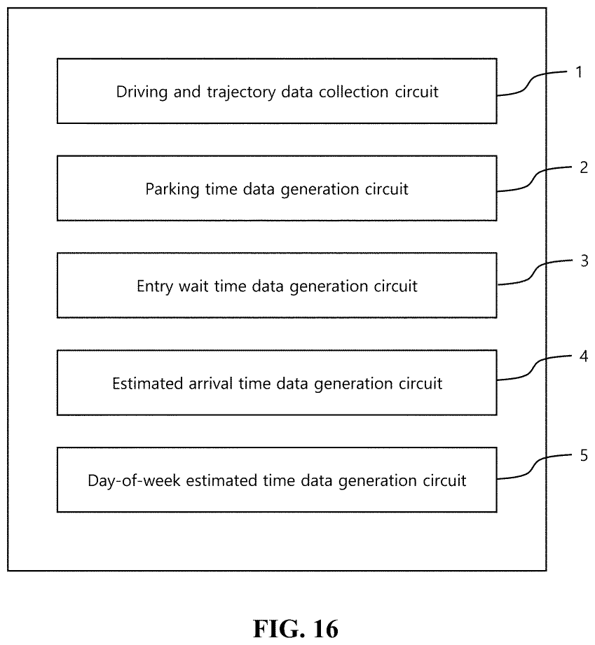

FIG. 16 is a view depicting an apparatus for providing traffic information for an estimated time of arrival at a point of interest (POI) in a navigation system according to an embodiment.

Referring to FIG. 16, the apparatus according to the present embodiment may include a driving and trajectory data collection circuit 1, a parking time data generation circuit 2, an entry wait time data generation circuit 3, an estimated arrival time data generation circuit 4, and a day-of-week estimated time data generation circuit 5.

Descriptions of the driving trajectory data collection circuit 1, the parking time data generation circuit 2, the entry wait time data generation circuit 3, the estimated arrival time data generation circuit 4, and the day-of-week estimated time data generation circuit 5 are identical to those of the method for providing traffic information for an estimated time of arrival at a point of interest (POI) in a navigation system, so further explanation will be omitted below.

According to the present embodiment, it is possible not only to estimate an expected time of arrival at a destination, i.e., a point of interest (POI), but also to predict a time spent on waiting after arrival and a time required to complete parking, thereby enabling a reduction in driving time to the destination.

Moreover, according to the present embodiment, estimated times of arrival and congestion levels may be provided by comparing multiple links leading to a point of interest (POI). Accordingly, if there are several entryways to a parking lot, it is possible to provide comparative analysis of times spent on entry and parking and provide predictions and comparisons of times required for arrival, allowing the user to select an entryway based on the situation. For large-scale parking facilities where it takes a considerable amount of time to park and wait, it is possible to significantly reduce the time required for parking and waiting.

Additionally, according to this embodiment, by providing an estimated time of arrival at a point of interest (POI) during route planning, users can determine in advance a route for entering the parking lot, thereby reducing driving time, entry wait time, and time required for parking.

Additionally, according to this embodiment, by providing an estimated time of arrival at a point of interest (POI) in real time, users can immediately deal with traffic situations, thereby providing enhanced services that promote user convenience and safe driving.

Various embodiments and their effects have been described with reference to FIGS. 1 through 16. The effects according to the technical concept of the present disclosure are not limited to those mentioned above, and other effects not explicitly stated will be clearly understood by a person of ordinary skill in the art based on the following description.

While operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Although exemplary embodiments of the present disclosure have been described above with reference to the accompanying drawings, it should be understood that those skilled in the art to which the present disclosure pertains will understand that the present disclosure may be embodied in other specific forms without changing the technical spirit or essential characteristics thereof. Therefore, it should be understood that the embodiments described above are illustrative in all respects and not restrictive. The scope of protection of the present disclosure should be interpreted by the following claims, and all technical ideas within the scope equivalent thereto should be construed as being included in the scope of the technical idea defined by the present disclosure.

What is claimed is:

1. A method for providing traffic information for an estimated time of arrival at a point of interest (POI) in a navigation system, the method comprising:
collecting driving data and trajectory data, the driving data including information of vehicles driving via links defined by a predefined route and the trajectory data including information obtained through a global positioning system (GPS) with respect to trajectories of the vehicles moving along a non-predefined route within a parking lot;
generating parking time data of the vehicles by deriving times required for the vehicles to park based on the trajectory data and integrating the times required for the vehicles to park;
deriving travel times of the vehicles traversing links leading to an entrance to the parking lot based on the driving data, calculating entry wait times of the vehicles during which the vehicles arrive at entrances of the links by aggregating the travel times, and generating entry wait time data by integrating the entry wait times of the vehicles; and
deriving estimated times of arrival of the vehicles by summing the times required for the vehicles to park and the entry wait times, and generating estimated arrival time data by integrating the estimated times of arrival of the vehicles.

2. The method of claim 1, wherein the driving data includes link IDs corresponding to the links leading to the entrance and the entry wait times, and the trajectory data includes position coordinates of the vehicles in motion collected through the global positioning system (GPS), trajectory information transmission times, and a number of trajectory records collected between consecutive trajectory information transmission times.

3. The method of claim 2, wherein each of the times required for the vehicles to park is defined as a value obtained by subtracting a parking lot entry time of each one of the vehicles from a parking completion time of said each one of the vehicles.

4. The method of claim 3, wherein, if the number of trajectory records collected within a trajectory information transmission interval falls short of a maximum number of trajectory records collected by more than a margin of error, a vehicle is deemed to be in a parked position, and a parking completion time of the vehicle is derived.

5. The method of claim 1, wherein the entry wait times are defined as a sum of the travel times through a number of consecutive links.

6. The method of claim 1, further comprising generating daily data and day-of-week data as the generated estimated arrival time data.

7. The method of claim 6, further comprising:
generating day-of-week estimated arrival time data through a pattern analysis of the day-of-week data; and
providing an estimated time of arrival in real time on a date and time when a vehicle is expected to arrive at the point of interest (POI) based on the day-of-week estimated arrival time data.

8. The method of claim 7, wherein, in the generating the day-of-week estimated arrival time data, the pattern analysis is performed by integrating N weeks of the day-of-week data.

9. The method of claim 8, wherein the pattern analysis includes an analysis in which a representative value is extracted from the N weeks of the day-of-week data.

10. The method of claim 9, wherein, in the providing of the estimated time of arrival in real time, a plurality of links leading to the entrance to the parking lot and estimated times of arrival corresponding to the plurality of links are further provided in real time.

11. The method of claim 10, wherein, in the providing of the estimated time of arrival in real time, a congestion level is determined according the estimated time of arrival, and the congestion level is further provided in real time.

12. The method of claim 11, wherein, the congestion level is light, moderate, or heavy.

13. A non-transitory computer-readable recording medium storing a program, when executed, perform a method for providing traffic information for an estimated time of arrival at a point of interest (POI) in a navigation system, the method comprising:
collecting driving data and trajectory data, the driving data including information of vehicles driving via links defined by a predefined route and the trajectory data including information obtained through a global positioning system (GPS) with respect to trajectories of the vehicles moving along a non-predefined route within a parking lot;
generating parking time data of the vehicles by deriving times required for the vehicles to park based on the trajectory data and integrating the times required for the vehicles to park;
deriving travel times of the vehicles traversing links leading to an entrance to the parking lot based on the driving data, calculating entry wait times of the vehicles during which the vehicles arrive at entrances of the links by aggregating the travel times, and generating entry wait time data by integrating the entry wait times of the vehicles; and
deriving estimated times of arrival of the vehicles by summing the times required for the vehicles to park and the entry wait times, and generating estimated arrival time data by integrating the estimated times of arrival of the vehicles.

14. An apparatus for providing traffic information for an estimated time of arrival at a point of interest (POI) in a navigation system, the apparatus including:
a driving and trajectory data collecting circuit for collecting driving data and trajectory data, the driving data including information of vehicles driving via links defined by a predefined route and the trajectory data including information obtained through a global positioning system (GPS) with respect to trajectories of vehicles moving along a non-predefined route within a parking lot;
a parking time data generation circuit for generating parking time data of the vehicles by deriving times required for the vehicles to park based on the trajectory data and integrating the times required for the vehicles to park;
an entry wait time data generation circuit for deriving travel times of the vehicles traversing links leading to an entrance to the parking lot based on the driving data, calculating entry wait times of the vehicles during which the vehicles arrive at entrances of the links by aggregating the travel times, and generating entry wait time data by integrating the entry wait times of the vehicles; and
an estimated arrival time data generation circuit for deriving estimated times of arrival of the vehicles by summing the times required for the vehicles to park and the entry wait times, and generating estimated arrival time data by integrating the estimated times of arrival of the vehicles.

15. The apparatus of claim 14, wherein, the driving data includes link IDs corresponding to the links leading to the entrance and entry wait times, and the trajectory data includes position coordinates of the vehicles in motion collected through the global positioning system (GPS), trajectory information transmission times, and a number of trajectory records collected between consecutive trajectory information transmission times.

16. The apparatus of claim 14, wherein, each of the times required for the vehicles to park is defined as a value obtained by subtracting a parking lot entry time of each one of the vehicles from a parking completion time of said each one of the vehicles.

17. The apparatus of claim 16, wherein, if a number of trajectory records collected within a trajectory information transmission interval falls short of a maximum number of trajectory records collected by more than a margin of error, a vehicle is deemed to be in parked position, and a parking completion time is derived.

18. The apparatus of claim 14, wherein, the entry wait times are defined as a sum of travel times through a number of consecutive links.

19. The apparatus of claim 14, further comprising:
a day-of-week estimated time data generation circuit for generating daily data and day-of-week data as the generated estimated arrival time data and for generating day-of-week estimated arrival time data through a pattern analysis of the day-of-week data; and
an estimated arrival time provision screen for providing on a display an estimated time of arrival in real time on a date and time when a vehicle is expected to arrive at the point of interest (POI) based on the day-of-week estimated arrival time data.

20. The apparatus of claim 19, wherein a congestion level is determined according the estimated time of arrival, and the determined congestion level is provided in real time.
